(19) United States
(12) Patent Application Publication
(10) Pub. No.: US 2003/0183957 A1
(43) Pub. Date: Oct. 2, 2003

(54) Downcomer vapor/liquid flood windows and hinged downcomer weir for reducing tray tower floodings

(76) Inventor: Nader Zarabi, Calgary (CA)

Correspondence Address: NADER ZARABI, #1502, 620, 67 Ave., S.W., CALGARY, AB, T2V OM2, CA

(21) Appl. No.: 10/114,025

(22) Filed: Mar. 28, 2002

(51) Int. Cl. B01D 47/00

(52) U.S. Cl. 261/114.4

(57) ABSTRACT

The invention is a downcomer with self adjusting, hinged; vapor/liquid flood windows and non-uniform downcomer weir for increasing the tray efficiency and reducing the tray tower flooding and operational/structural instability.

### BACKGROUND OF THE INVENTION

Tray-tower is the heart of many chemical processes in chemical and petrochemical plants, refineries, food processing units, and so on. Tower performance directly affects the quality/value of the products, overall performance of the processes and economics of the plant.

One of the key parameter in the efficiency of the tray is uniformity of liquid distribution on the tray, which currently is addressed by special structural design of the valves on the tray to diverge the liquid to the sides of the tray.

Also, one of the key parameters in tray tower design is vapor/liquid ratio. Designing the tower for wide vapor/liquid ratio results in exotic trays design and increases the cost of tower which may not still stand the sudden vapor rate increase such as water vaporization in hot towers.

There are two types of flooding in tray towers; (1) “Entrainment flooding” which happens due to high vapor rate and (2) “Downflow flooding” which happens due to high liquid rate. High vapor flow rate may result in foaming, entrainment, high-pressure drop across the trays, lifting the tray and potential damage to tray structure. High liquid rate floods the trays, reduces the vapor upward flow through the tower, and increases the load on the trays and tower structure. Usually, downflow flooding starts in downcomer as its cross sectional area is small comparing to the tower cross sectional area.

In today design, tray holes/valves are the only openings for vapor passage and downcomer weirs are the only opening for liquid passage through the tower. As these openings are sized for normal flow rates, there is a very limited extra liquid/vapor flow that can pass through these openings.

The present invention of non-uniform downcomer weir with larger openings on the sides provides better liquid distribution on the edges of the tray (including the exit end of the tray) and increases the tray efficiency.

Also, the present invention is for providing extra vapor/liquid passage area though hinged weir and vapor/liquid windows on downcomer that are hydraulically closed at normal vapor/liquid rates and automatically open to bypass extra vapor/liquid flows. By doing so, higher vapor/liquid flow on a tray is bypassed/transferred to next trays to give smoother operation and lower structural load on the tower.

### SUMMARY OF THE INVENTION

My invention is a modification to downcomer design of tray towers for providing the said hinged and non-uniform downcomer weir plus vapor/liquid windows for bypassing extra vapor/liquid flows to the next tray. The non-uniform downcomer has larger openings on the sides, which diverges more liquid to the edges of the tray and by better liquid distribution increases the tray efficiency. Also, hinged weir and vapor/liquid windows allow the whole volume (comparing to the volume between two adjacent trays) of the tower to be used as a buffer volume to absorb the sudden increase in vapor/liquid flow rates.

The hinged downcomer weir is a flapper hinged at the bottom of the downcomer. It opens/closes automatically as the liquid level in downcomer rises/drops, respectively. Therefore, the downcomer weir opening corresponds to the liquid flow rate on the tray and is self-adjusting. The non-uniform weir is a single weir or a combination of three independent weirs having larger opening on the sides.

The vapor/liquid windows are flapper, which are hinged to the downcomer and open or close by swinging vertically on the hinge. Liquid/vapor build-up at the inlet of the windows increases the pressure at the inlet side of the gates and opens the gates corresponding to the liquid/vapor pressure build up. Therefore, the higher liquid/vapor build-up results in more flapper opening and higher liquid/vapor flow through the window. As the liquid/vapor is passed through the window to the next tray, the pressure difference between inlet and outlet of the window reduces and the flapper position is balanced accordingly. Therefore, the liquid/vapor windows are also self-adjusting similar to hinged downcomer.

This new design can be applied to both existing and new towers. Depends on the size of the tower and pressure drop across the trays, one or more of each vapor/liquid windows can be installed on each downcomer. If a tower is specifically designed of longer or larger diameter to stand the vapor/liquid disturbances, vapor/liquid windows can reduce the tower length/diameter. The hinged downcomer weir and vapor/liquid windows are maintenance free and by being closed at normal rates, do not interfere with normal operation of the tower.

### DESCRIPTION OF THE FIGURES

FIG. 1 shows the today design of a downcomer, flow of liquid and vapor inside a tower, and pressure at different points of two typical trays and a downcomer.

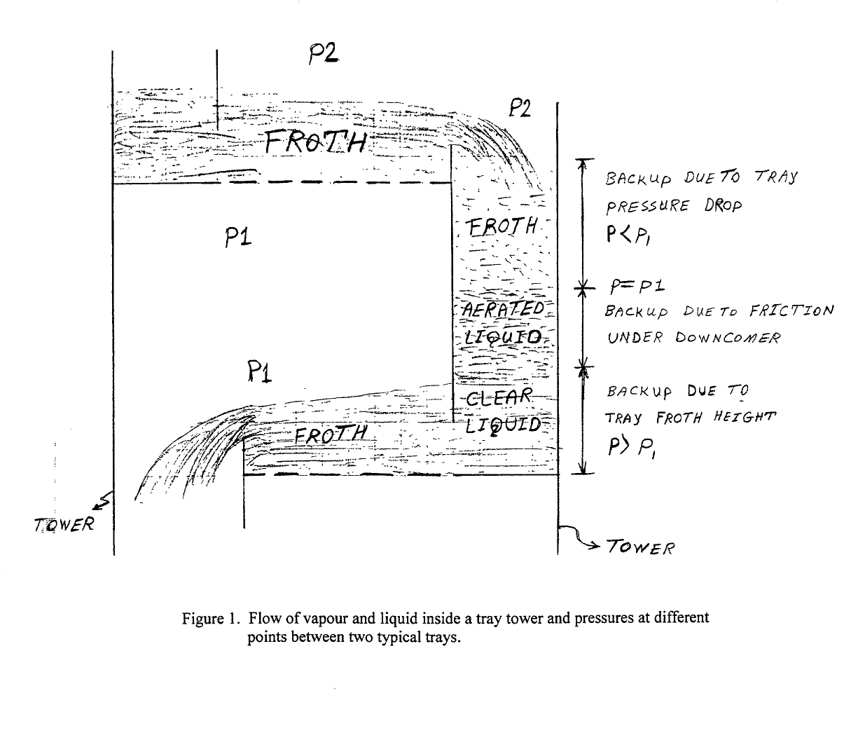

FIG. 2 shows the relative location, installation, and opening of hinged downcomer weir and vapor/liquid windows on a typical downcomer. Note that for downcomer with multiple windows, the sizes of the windows do not need to be the same.

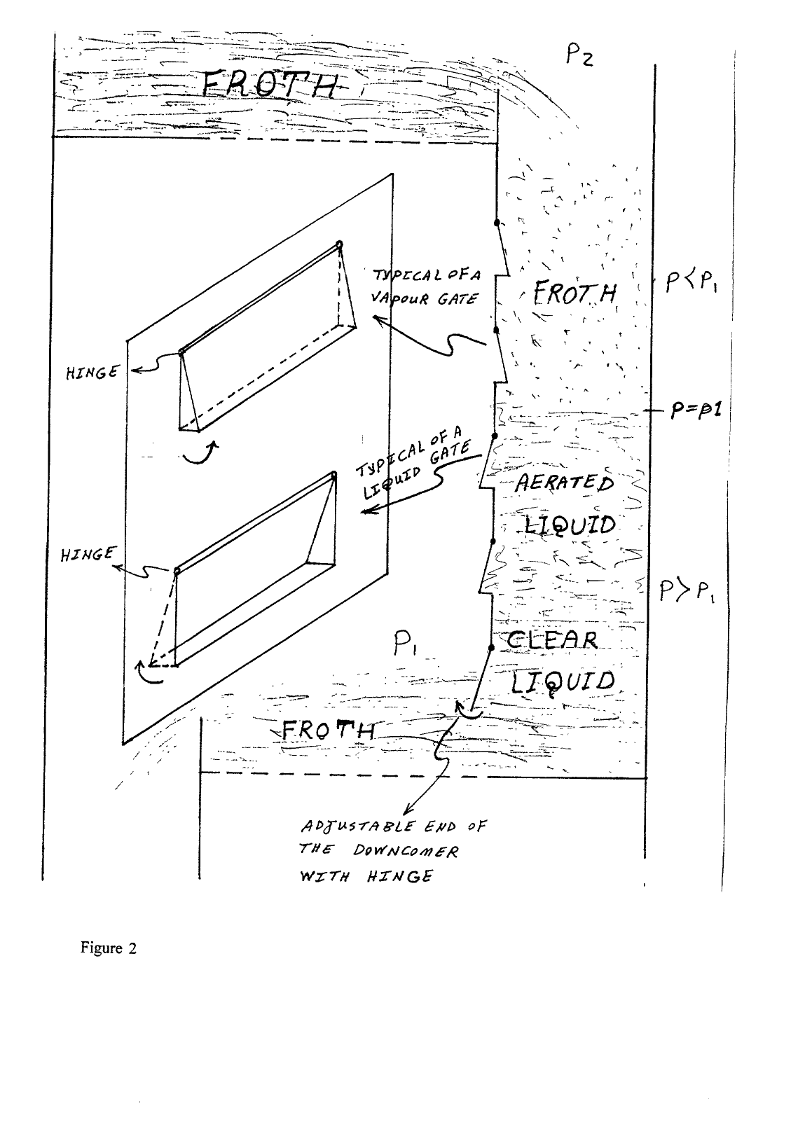

FIG. 3 shows the force distributions on hinged weir and vapor/liquid gates and the mechanism of their operation (self-adjustment). Note that weir and flappers are slightly angled at the rest position to be closed at normal operation.

FIG. 4 shows a typical arrangement for multiple vapor/liquid windows in a single row and non-uniform hinged weir. The flappers in all of these structures are independent. The non-uniform weir can be a combination of two smaller and independent flappers on the sides and a bigger flapper in the middle (as shown in FIG. 4) or a single flapper with two cuts on the sides.

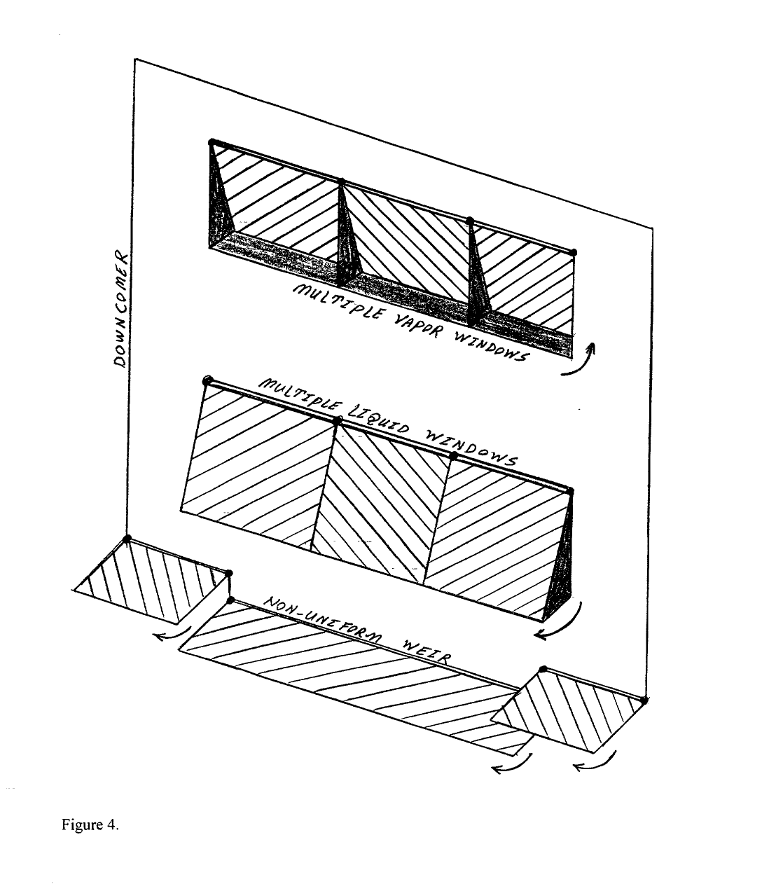

### DETAILED DESCRIPTION OF THE INVENTION

The presented invention is the downcomer of tray towers with non-uniform and hinged downcomer weir and vapor/liquid windows for increasing the tray efficiency and stability of the tower operation by providing extra openings for transferring extra liquid/vapor flow to the next trays. The hinged weir and vapor/liquid windows are designed to be closed at normal operation and to open at higher than normal vapor/liquid flow rates. The weir/window opening corresponds to the amount of extra flow. In other words, the higher the flow, the larger the opening will be and vice versa.

The vapor/liquid gates are simple plates (flapper) which are hinged to the downcomer. As explained below, the surface area and weight of the flapper are important design parameters. The lighter flapper is more sensitive to the flow fluctuations. The larger flapper provides larger flow openings for liquid/vapor flow.

The hinge can be as simple as nail-shell structure that has been used as door hinge for centuries. However, in severe environment like inside a distillation tower, the hinged shall be sealed enough to prevent corrosion and debris build-up inside the hinge that can jam the hinge (flapper).

The non-uniform weir can be a single plate (flapper) with two cuts on the sides or a combination of two smaller and independent flappers on the sides and a larger independent flapper in the middle. The smaller flappers on the sides mean larger opening on the sides for passage of the liquid. As the liquid is pushed more to the edges of the trays (including the tray exit end), liquid is distributed more uniformly on the tray which will increase the tray efficiency.

As the downward flow of liquid increases, the height of the liquid in downcomer increases and so the pressure at the inlet of the hinged weir and liquid flapper. If there is enough pressure differential on two sides of the flapper, the flapper will open corresponding to the pressure force difference. Note that if both liquid window and hinged downcomer exist together, downcomer hinged weir opens before the liquid window. If the liquid flow is beyond the capacity of the hinged weir, the liquid level rises in the downcomer and opens the liquid window according to the liquid level inside downcomer. The parameters that affect the hinged weir/liquid window opening are; surface area of the flapper, angle of the flapper from vertical position (window opening), weight of the flapper, density of the liquid, pressure differential across the corresponding tray, and liquid level in the downcomer.

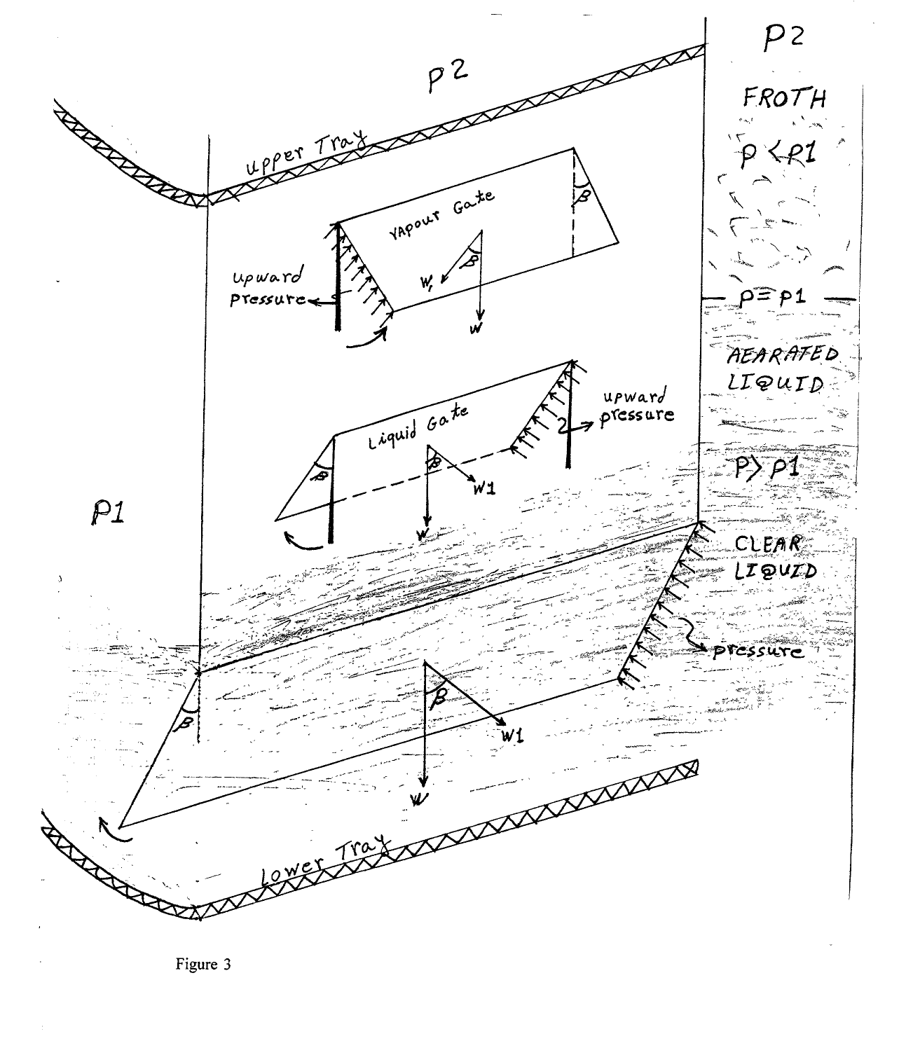

The following formula shows the opening force of a liquid flapper and the effective parameters. Note that friction loses in window hinges are ignored. See FIG. 3 for force distribution on a liquid gate.

(P − P₁) A = W (Sinβ)
P = 92 gh
where ρ: liquid density
g: acceleration of gravity (constant)
h: liquid height difference on two sides of the flapper
P: pressure at the window inlet
P₁: pressure at the window outlet
A: surface area of the flapper
W: weight of the flapper
β: angle of the flapper from vertical

On the other hand, as the upward flow of vapor increases, the pressure at the inlet of vapor window increases. If there is enough pressure differential between the two sides of the vapor flapper, it opens corresponding to the pressure differential. Except for the liquid density, all the parameters mentioned above for liquid windows are also valid for the design of vapor windows. The following formula shows the opening force of a vapor window and the effective parameters. Note that the friction loses in window hinges are ignored. See FIG. 3 for force distribution on a vapor window.

(P − P₁) A = W (Sinβ)
Where P: pressure at the window inlet
P₁: pressure at the window outlet
A: surface area of the flapper
W: weight of the flapper
β: angle of the flapper from vertical

The vapor/liquid windows are specifically more effective at trays nearby to feed and product trays, where there is usually variation in liquid/vapor flow rate and/or ratio. Moreover, vapor window at the top trays can prevent tower entrainment, effectively.

1. The variable and non-uniform downcomer weir in tray towers.

2. The windows (openings) on downcomer area for providing extra liquid/vapor flow areas beyond the tray holes/valves and downcomer weir.

3. The gates on liquid/vapor windows of claim 2, for controlling the flow through these windows.

4. The downcomer weir in claim 1, which is self-adjusting according to the offset flow and pressure force balance on the weir.

5. The downcomer weir in claim 1, which is hinged to the downcomer bottom end and opens/closes by rotating around the hinge (angle from vertical position) based on the pressure difference across the weir.

6. The downcomer weir in claim 1, which is a multiple of two smaller and independent gates on the sides and a larger independent gate in the middle.

7. The downcomer weir in claim 1, which is a single weir with non-uniform cut on the sides to provide larger openings on the sides.

8. The windows in claim 2, which are single or multiple openings installed in a single row or multiple rows.

9. The liquid/vapor gates in claim 3, which are self-adjusting according to the offset flow of liquid and vapor and pressure force balance on the inlet and outlet of the gates.

10. The liquid/vapor gates in claim 3, which are hinged to the downcomer surface and open/close by rotating around the hinge (angle from vertical position) depending on the liquid/vapor pressure force balance across the gate.
